(19) United States
(12) Patent Application Publication
(10) Pub. No.: US 2018/0011439 A1
(43) Pub. Date: Jan. 11, 2018

(54) IMAGE FORMING APPARATUS

(71) Applicant: CANON KABUSHIKI KAISHA, Tokyo (JP)

(72) Inventor: Kengo Sato, Koshigaya-shi (JP)

(21) Appl. No.: 15/635,603

(22) Filed: Jun. 28, 2017

(30) Foreign Application Priority Data
Jul. 7, 2016 (JP) 2016-134646

(51) Int. Cl. G03G 15/00

(52) U.S. Cl. CPC G03G 15/6529

(57) ABSTRACT

Provided is an image forming apparatus including a secondary transfer portion which transfers a toner image onto a recording material; a fixing device which fixes the toner image onto the recording material, and a belt conveying portion which adsorbs the recording material between the secondary transfer portion and the fixing device, and conveys the recording material, in which the belt conveying portion includes a first velocity at the time of receiving a front end portion of the recording material in a traveling direction from the secondary transfer portion, and a second velocity before a rear end portion of the recording material in the traveling direction leaves the secondary transfer portion at the time of delivering the front end portion of the recording material in the traveling direction to the fixing device, and the second velocity is faster than the first velocity.

### BACKGROUND OF THE INVENTION

### Field of the Invention

The present invention relates to an image forming apparatus such as a copying machine, a printer, and a facsimile machine.

### Description of the Related Art

In the related art, an image forming apparatus is known in which a toner image on an image bearing member such as a photoconductive drum, which is formed by exposure and developing, is transferred onto a recording material through an intermediate transfer member such as an intermediate transfer belt. After that, the toner image is thermally fused by being heated and pressurized by a fixing device including a fixing film, a fixing roller, or the like, and is heat-fixed onto the recording material.

In Japanese Patent Laid-Open No. 2006-251441 and Japanese Patent Laid-Open No. H06-250462, a recording material is sensed between a transfer portion and a fixing portion which are arranged at an interval which is longer than the length of a recording material to be used, and on the basis of the sensing result, the conveying belt is controlled such that the velocity increases after a rear end of the recording material leaves the transfer portion. Then, a front end of the recording material reaches the fixing portion after the rear end of the recording material leaves the transfer portion. The interval between the transfer portion and the fixing portion is longer than the length of the recording material, and thus, a device is large.

In a comparatively small device where an interval between a transfer portion and a fixing portion is shorter than the length of a recording material, pulling or an excessive loop of the recording material occurs due to a conveyance velocity difference between the transfer portion and the fixing portion. As a result thereof, there is a case where the behavior of the recording material becomes unstable, and thus, a jam occurs, the recording material is skew-fed and turned, and thus, an image position is shifted, or impact or vibration is imparted to the transfer portion or an image forming portion positioned on the upstream of the transfer portion, and thus, image blurring or a color shift occurs. In Japanese Patent Laid-Open No. 2007-017538 or Japanese Patent Laid-Open No. 2003-345150, it is disclosed that when the recording material is nipped in both the transfer portion and the fixing portion, a relative velocity between a conveyance velocity of the recording material in the transfer portion and a conveyance velocity of the recording material in the fixing portion is changed.

However, in the case of a configuration including a conveying belt which sucks the recording material between the transfer portion and the fixing portion, and conveys the recording material, it is insufficient to adjust the relative velocity between the conveyance velocity of the recording material in the transfer portion and the conveyance velocity of the recording material in the fixing portion. Unless the relative velocity between the conveyance velocity of the recording material in the transfer portion and the conveyance velocity of the recording material in the conveying belt, and a relative velocity between a conveyance velocity of the recording material in the conveying belt and the conveyance velocity of the recording material in the fixing portion are similarly proper, there may be problems as described above.

In particular, in a case where the relative velocity between the conveyance velocity of the recording material in the conveying belt and the conveyance velocity of the recording material in the fixing portion is not proper, there may be an image disturbance in a fixing nip portion of the fixing portion, or a wrinkle, a breakage, or the like of the recording material, in addition to the problems described above.

It is desirable to provide an image forming apparatus which is capable of suppressing the occurrence of the image disturbance, or the wrinkle, the breakage, or the like of the recording material.

### SUMMARY OF THE INVENTION

A representative configuration of an image forming apparatus, comprising: a transfer portion which transfers a toner image onto a recording material; a fixing portion which fixes the toner image onto the recording material; and a belt conveying portion which includes a belt that adsorbs the recording material between the transfer portion and the fixing portion, and conveys the recording material, wherein the belt conveying portion conveys the recording material at a first velocity at the time of receiving a front end portion of the recording material in a traveling direction from the transfer portion, and the belt conveying portion conveys the recording material at a second velocity before a rear end portion of the recording material in the traveling direction leaves the transfer portion at the time of delivering the front end portion of the recording material in the traveling direction to the fixing portion, and the second velocity is faster than the first velocity.

Further features of the present invention will become apparent from the following description of exemplary embodiments with reference to the attached drawings.

### BRIEF DESCRIPTION OF THE DRAWINGS

FIG. 1 is a sectional explanatory diagram illustrating a configuration of an image forming apparatus according to the invention;

FIG. 2 is a block diagram illustrating a configuration of a control system of the image forming apparatus according to the invention;

FIG. 3 is a perspective explanatory diagram illustrating a configuration between a transfer portion and a fixing portion;

FIG. 4 is a sectional explanatory diagram illustrating the configuration between the transfer portion and the fixing portion;

FIG. 5 is a perspective explanatory diagram illustrating a configuration of a belt conveying portion;

FIG. 6 is a sectional explanatory diagram illustrating the configuration of the belt conveying portion;

FIG. 7 is a plan explanatory diagram illustrating a configuration of a neutralizing plate;

FIG. 8 is a sectional explanatory diagram illustrating the configuration of the neutralizing plate;

FIG. 9 is a flowchart illustrating control of a variable velocity of a conveying belt;

FIG. 10 is a timing chart diagram illustrating the control of the variable velocity of the conveying belt;

FIG. 11 is a perspective explanatory diagram illustrating a mechanism in which an image disturbance, a wrinkle, a breakage, or the like occurs in the fixing nip portion;

FIG. 12 is a perspective explanatory diagram illustrating the mechanism in which the image disturbance, the wrinkle, the breakage, or the like occurs in the fixing nip portion;

FIG. 13 is a plan explanatory diagram illustrating an example in which an image disturbance occurs;

FIG. 14A is a sectional explanatory diagram illustrating a behavior of a recording material at the time of performing the control of the variable velocity of the conveying belt;

FIG. 14B is a sectional explanatory diagram illustrating the behavior of the recording material when the control of the variable velocity of the conveying belt is not performed;

FIG. 15 is a diagram illustrating an effect of suppressing an image disturbance at the time of performing the control of the variable velocity of the conveying belt;

FIG. 16 is a sectional explanatory diagram illustrating a configuration of a sensor portion sensing a loop amount of the recording material between the conveying belt and the transfer portion; and

FIG. 17 is a timing chart diagram illustrating control of the loop amount of the recording material.

### DESCRIPTION OF THE EMBODIMENTS

An embodiment of an image forming apparatus according to the invention will be described in detail according to the drawings.

### <Image Forming Apparatus>

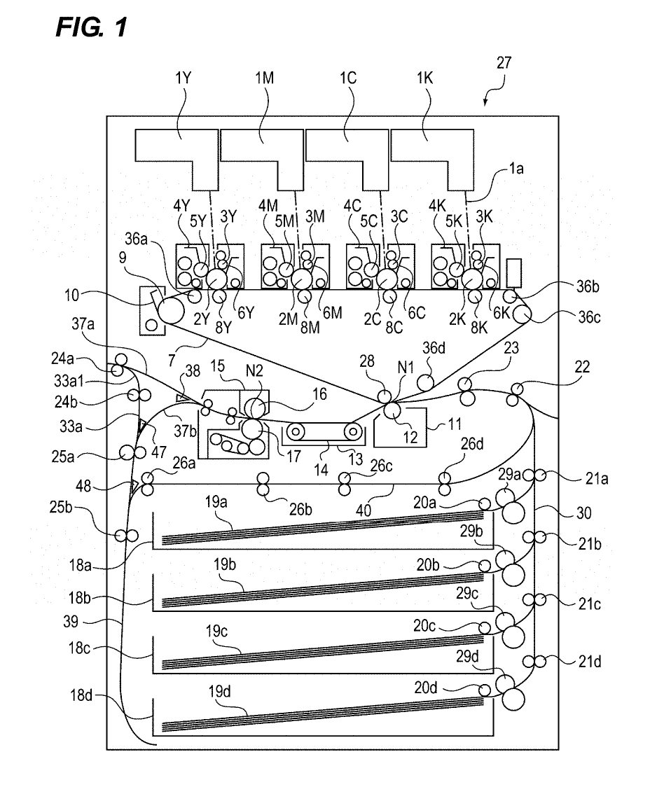

First, a configuration of an image forming apparatus according to the invention will be described by using FIG. 1. FIG. 1 is a sectional explanatory diagram illustrating the configuration of the image forming apparatus according to the invention. In FIG. 1, laser scanners 1Y, 1M, 1C, and 1K, which become an image exposing portion, are provided. Photoconductive drums 2Y, 2M, 2C, and 2K, which become an image bearing member, are provided. Furthermore, the photoconductive drum 2 will be described as a representative of the photoconductive drums 2Y, 2M, 2C, and 2K. The same applies to other image forming process portions.

Charging rollers 3Y, 3M, 3C, and 3K, which become a charging portion charging a front surface of the photoconductive drum 2 of each color of yellow Y, magenta M, cyan C, and black K, are provided in each color station. Developing devices 4Y, 4M, 4C, and 4K, which become a developing portion performing developing by using a toner of each of the colors of yellow Y, magenta M, cyan C, and black K, are provided in each of the color stations. Developing sleeves 5Y, 5M, 5C, and 5K, which become a developer bearing member conveying a developer (the toner) of each of the colors to each of the photoconductive drums 2, are provided in each of the developing devices 4. Cleaners 6Y, 6M, 6C, and 6K, which become a cleaning portion cleaning the front surface of the photoconductive drum 2, are provided.

An intermediate transfer belt 7, which becomes an intermediate transfer member, is provided. Primary transfer rollers 8Y, 8M, 8C, and 8K, which become a primary transfer portion, are provided. Driving roller 9, which rotatively drives the intermediate transfer belt 7, is provided. The intermediate transfer belt 7 is rotatably stretched in a clockwise direction of FIG. 1, by a driving roller 9, tension rollers 36a to 36d, and an inner transfer roller 28. Each primary transfer roller 8, which becomes a primary transfer portion, is provided on an inner circumferential surface side of the intermediate transfer belt 7 to face each of the photoconductive drums 2. A cleaner 10, which becomes a cleaning portion cleaning the outer circumferential surface of the intermediate transfer belt 7, is provided.

### <Transfer Portion>

A secondary transfer portion 11 is provided. The secondary transfer portion 11 is configured as a transfer portion transferring a toner image onto a recording material 19. A secondary transfer roller 12, which becomes a secondary transfer portion, is provided. A secondary transfer nip portion N1 is formed on the outer circumferential surface of the intermediate transfer belt 7 by the secondary transfer roller 12. The recording material 19 is nipped and conveyed by the outer circumferential surface of the intermediate transfer belt 7 and the secondary transfer roller 12 in the secondary transfer nip portion N1. At this time, a conveyance velocity V of the recording material 19 is the conveyance velocity V of the recording material 19 in the secondary transfer portion 11 (the transfer portion).

### <Belt Conveying Portion>

A belt conveying portion 13 is provided. The belt conveying portion 13 is configured as a belt conveying portion which adsorbs the recording material 19 between the secondary transfer portion 11 (the transfer portion) and the fixing device 15 (the fixing portion) and conveys the recording material 19. A conveying belt 14 is provided. An outer circumferential surface of the conveying belt 14 is configured as a surface of the conveying belt. The conveyance velocity V of the recording material 19, which is adsorbed on the outer circumferential surface of the conveying belt 14 and is conveyed by rotating the conveying belt 14, is the conveyance velocity V of the recording material 19 in the belt conveying portion 13.

### <Fixing Portion>

A fixing device 15, which becomes a fixing portion heat-fixing the toner image onto the recording material 19, is provided. A fixing roller 16 is provided. A pressure roller 17 is provided. A fixing nip portion N2 of the fixing portion is formed by the fixing roller 16 and the pressure roller 17. The recording material 19 is nipped and conveyed by the fixing roller 16 and the pressure roller 17 in the fixing nip portion N2. At this time, the conveyance velocity V of the recording material 19 is the conveyance velocity V of the recording material 19 in the fixing device 15 (the fixing portion).

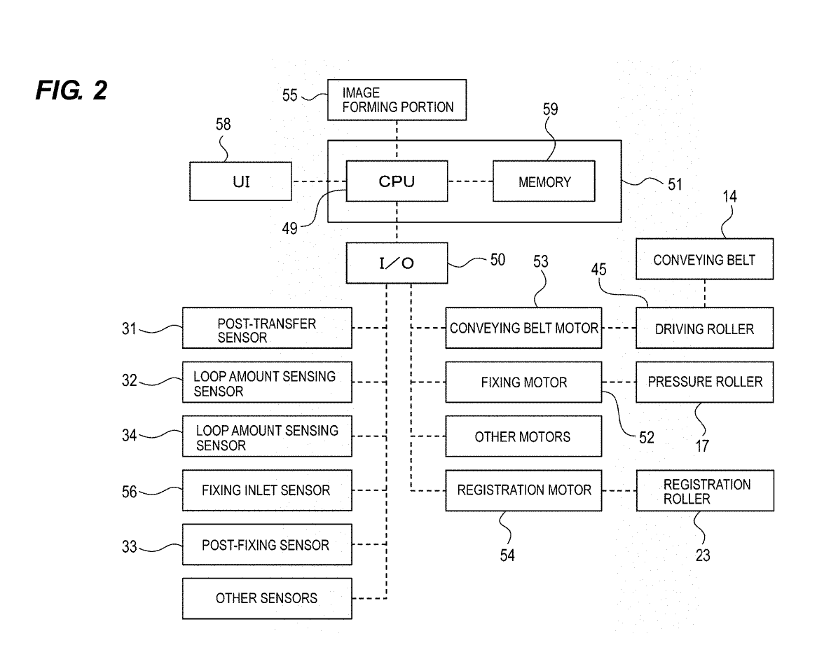

Sheet cassettes 18a to 18d are provided. Recording materials 19a to 19d are provided. Sheet rollers 20a to 20d are provided. Intermediate conveying rollers 21a to 21d are provided. A pre-registration roller 22 is provided. A registration roller 23 is provided. A registration motor 54, which becomes a driving source, is driven and controlled by a CPU 49, which is a controller illustrated in FIG. 2, through an input/output device (I/O) 50, and thus, the registration roller 23 is rotatively driven. Discharge rollers 24a and 24b are provided. Reversing rollers 25a and 25b are provided. Duplex conveying rollers 26a to 26d are provided.

### <Controller>

Next, a configuration of a control system of the image forming apparatus 27 will be described by using FIG. 2. FIG. 2 is a block diagram illustrating the configuration of the control system of the image forming apparatus according to the invention. In FIG. 2, a printing job condition is set by a user interface (UI) 58 or a personal computer (PC). Then, the image forming portion 55 is controlled by the controller 51 of the image forming apparatus 27 the central processing unit (CPU) 49, which becomes the controller, or a memory 59 according to the set printing job condition. In addition, various sensors or various motors are controlled by the controller 51 through the input/output device (I/O) 50.

Various sensors, which become a sensing portion, include a post-transfer sensor 31, a loop amount sensing sensor 32, a post-fixing sensor 33, a loop amount sensing sensor 34, a fixing inlet sensor 56, and an environmental sensor 60, and each sensing result from the sensors is imparted to the CPU 49 through the input/output device (I/O) 50. Various motors, which become a driving source, include a fixing motor 52, a conveying belt motor 53, and a registration motor 54, and the motors are driven and controlled by the CPU 49 through the input/output device (I/O) 50.

The conveying belt motor 53 rotatively drives the driving roller 45 and rotatively drives the conveying belt 14. The fixing motor 52 rotatively drives the pressure roller 17, and rotatively drives the fixing device 15. Accordingly, the CPU 49 (the controller) controls the conveyance velocity V of the recording material 19 in the fixing device 15 (the fixing portion). The registration motor 54 rotatively drives the registration roller 23.

### <Image Forming Operation>

Next, an image forming operation of the image forming apparatus 27 will be described. In each of the photoconductive drums 2 illustrated in FIG. 1, an outer circumference of an aluminum cylinder is coated with an organic photoconductive layer, and a rotative driving force of the motor, which becomes the driving source (not illustrated), is imparted to the photoconductive drum 2, and thus, the photoconductive drum 2 is rotated in a counterclockwise direction of FIG. 1 according to the image forming operation.

The front surface of each of the photoconductive drums 2 rotated in the counterclockwise direction of FIG. 1 is evenly charged by each charging roller 3. The front surface of each of the photoconductive drums 2, which is evenly charged, is irradiated with laser light la according to image information applied from each laser scanner 1, on the basis of image data transmitted from the controller 51 illustrated in FIG. 2, and thus, the front surface of each of the photoconductive drums 2 is selectively exposed. Accordingly, an electrostatic latent image is formed on the front surface of each of the photoconductive drum 2. The toner of each of the colors, which is borne on a front surface of each developing sleeve 5 is supplied onto the electrostatic latent image formed on the front surface of each of the photoconductive drums 2, and thus, is developed as a toner image and is visualized.

On the other hand, the outer circumferential surface of the intermediate transfer belt 7 is in contact with the front surface of each of the photoconductive drums 2, and is rotatively driven in the clockwise direction of FIG. 1 by the driving roller 9 at the time of forming an image. The toner image formed on the front surface of each of the photoconductive drums 2 is subsequently superimposed on the outer circumferential surface of the intermediate transfer belt 7 and is primarily transferred onto the outer circumferential surface of the intermediate transfer belt 7, according to the rotation of the front surface of each of the photoconductive drums 2 and each primary transfer roller 8 which abuts on the front surface of each of the photoconductive drums 2.

The secondary transfer roller 12 facing the inner transfer roller 28 through the intermediate transfer belt 7 is in contact with the outer circumferential surface of the intermediate transfer belt 7 at the time of forming an image, and the recording material 19 is nipped and conveyed by the outer circumferential surface of the intermediate transfer belt 7 and the secondary transfer roller 12. In the secondary transfer roller 12, a secondary transfer bias is applied from a secondary transfer bias power source (not illustrated), and the toner image on the outer circumferential surface of the intermediate transfer belt 7 is collectively secondarily transferred onto the recording material 19. The secondary transfer roller 12 abuts on the outer circumferential surface of the intermediate transfer belt 7 while the toner image on the outer circumferential surface of the intermediate transfer belt 7 is secondarily transferred onto the recording material 19, but is separated from the outer circumferential surface of the intermediate transfer belt 7 in a case where the image forming operation is ended.

The fixing device 15 (the fixing portion) includes the fixing roller 16 heating the recording material 19, and the pressure roller 17 pressing the recording material 19 against the fixing roller 16. The fixing roller 16 is formed in the shape of a hollow, and a heater (not illustrated) is embedded in the fixing roller 16. The secondarily transferred toner image is heated and pressurized during the recording material 19 is nipped and conveyed by the fixing roller 16 and the pressure roller 17, is thermally fused, and is heat-fixed onto the recording material 19.

In a case where the image forming operation is ended, each cleaner 6 of each of the photoconductive drums 2 performs cleaning by scraping the toner remaining on the front surface of the photoconductive drum 2. In addition, the cleaner 10 of the intermediate transfer belt 7 performs cleaning by scraping the toner remaining on the outer circumferential surface of the intermediate transfer belt 7. The toner image formed on the front surface of the photoconductive drum 2 is primarily transferred onto the outer circumferential surface of the intermediate transfer belt 7. After that, the toner remaining on the front surface of the photoconductive drum 2 or the toner remaining on the outer circumferential surface of the intermediate transfer belt 7 after the toner image formed on the outer circumferential surface of the intermediate transfer belt 7 is secondarily transferred onto the recording material 19 is accumulated in a cleaner vessel (not illustrated).

### <Conveyance Operation>

Next, a conveyance operation of the recording material 19 in the image forming apparatus 27 will be described. In the sheet cassettes 18a to 18d illustrated in FIG. 1, any sheet cassette 18 is selected, and the recording material 19 fed from the sheet cassette 18 by the sheet roller 20 is separately fed one by one in cooperation with a separating portion (not illustrated).

After that, the recording material 19 is nipped and conveyed by the conveying roller 29 and converges on a conveyance path 30, and then, is fed to the pre-registration roller 22 by the intermediate conveying rollers 21a to 21d. Then, skew feeding is corrected according to the stiffness of the recording material 19 abutting on a nip portion of the registration roller 23 in which a front end portion of the recording material 19 which is nipped and conveyed by the pre-registration roller 22 in a traveling direction is temporarily suspended.

The registration roller 23 feeds the recording material 19 to the secondary transfer nip portion N1 which is formed of the secondary transfer roller 12 and the outer circumferential surface of the intermediate transfer belt 7, in synchronization with the exposure of the laser scanner 1. Then, the secondary transfer bias is applied to the secondary transfer roller 12, and the toner image on the outer circumferential surface of the intermediate transfer belt 7 is secondarily transferred onto the recording material 19.

After that, the recording material 19 bearing an unfixed toner image conveyed to the fixing device 15 while being sucked by the conveying belt 14 disposed in the belt conveying portion 13. Then, the recording material 19 is nipped and conveyed by the fixing roller 16 and the pressure roller 17 disposed in the fixing device 15. In such a procedure, the toner image which is secondarily transferred by being heated and pressurized is heat-fixed onto the recording material 19.

### <Straight Discharge>

In a case where the recording material 19 onto which the toner image is fixed is straightly discharged in a state where the toner image is directed towards an upper side through a conveyance path 37a, the recording material 19 passing through the fixing device 15 is guided to a conveyance path 37a by rotating a flapper 38, and then, is delivered to a discharge roller 24a.

### <Reversing Discharge>

Front and rear surfaces of the recording material 19 onto which the toner image is fixed are reversed through a reversing conveyance path 39 from the conveyance path 37b, and the recording material 19 is reversely discharged in a state where the toner image is directed towards a lower side. In this state, the recording material 19 passing through the fixing device 15 is guided to the conveyance path 37b by rotating the flapper 38, and then, is delivered to the reversing roller 25a disposed in the reversing conveyance path 39.

The reversing roller 25a can be forwardly and reversely rotated. The reversing roller 25a receives the recording material 19 from the fixing device 15, and then, is reversely rotatively driven at a predetermined timing, and delivers the recording material 19 to discharge rollers 24a and 24b. Accordingly, the recording material 19 is discharged to the outside of the main body of the image forming apparatus 27 in a state where the front and rear surfaces of the recording material 19 are reversed. Alternatively, the recording material 19 is delivered to a post treatment device (not illustrated), and is subjected to a predetermined post treatment, and then, a printing operation is ended. The conveyance paths 37a and 37b are suitably switched by rotating the flapper 38 illustrated in FIG. 1 according to the setting of the straight discharge and the reversing discharge, the discharge roller 24a or the reversing roller 25a is suitably selected, and the recording material 19 is delivered to the discharge roller 24a or the reversing roller 25a.

### <Duplex Printing>

In a case where the front and rear surfaces of the recording material 19 are subjected to duplex printing, the recording material 19 passing through the fixing device 15 is guided to the conveyance path 37b by rotating the flapper 38, and then, is delivered to the reversing rollers 25a and 25b disposed in the reversing conveyance path 39. Both the reversing rollers 25a and 25b can be forwardly and reversely rotated. At the time of performing the duplex printing, the recording material 19 is conveyed up to the reversing roller 25b, and after that, the reversing roller 25b is reversely rotatively driven, and the recording material 19 is delivered to the duplex conveying rollers 26a to 26d disposed in a duplex conveyance path 40.

The duplex conveying rollers 26a to 26d convey again the recording material 19 to the conveyance path 30, and feed the recording material 19 from the pre-registration roller 22 to the registration roller 23. At this time, the front and rear surfaces of the recording material 19 are reversed, and in the secondary transfer nip portion N1, the secondary transfer bias is applied to the secondary transfer roller 12, and the toner image on the outer circumferential surface of the intermediate transfer belt 7 is secondarily transferred onto a second surface (the rear surface) of the recording material 19. Accordingly, the front and rear surfaces of the recording material 19 are subjected to the duplex printing.

The conveyance path is switched to the conveyance path 37b by rotating the flapper 38 illustrated in FIG. 1 according to the setting of the reversing discharge and the duplex printing. The flappers 47 and 48 are biased in one direction by a biasing portion (not illustrated), are pushed and rotated against a biasing force of the biasing portion by the passing recording material 19, and are returned to a home position by the biasing force of the biasing portion in a case where the recording material 19 passes.

The flapper 47 is pushed against the biasing force of the biasing portion by the recording material 19 passing through the conveyance path 37b, is rotated in the clockwise direction of FIG. 1, and is rotated in the counterclockwise direction of FIG. 1 by the biasing force of the biasing portion in a case where the recording material 19 passes, and thus, the reversing conveyance path 39 is opened. The flapper 48 is pushed against the biasing force of the biasing portion by the recording material 19 passing through the reversing conveyance path 39, is rotated in the counterclockwise direction of FIG. 1, and is rotated in the clockwise direction of FIG. 1 by the biasing force of the biasing portion in a case where the recording material 19 passes, and thus, the duplex conveyance path 40 is opened.

Accordingly, delivering the recording material 19 guided to the reversing conveyance path 39 to the reversing rollers 25a and 25b or delivering the recording material 19 guided to the reversing conveyance path 39 to the duplex conveying rollers 26a to 26d disposed in the duplex conveyance path 40 are switched.

In the secondary transfer nip portion N1, the secondary transfer bias is applied to the secondary transfer roller 12, and the toner image on the outer circumferential surface of the intermediate transfer belt 7 is secondarily transferred onto the recording material 19. After that, the recording material 19 is conveyed to the fixing device 15 while being sucked by the conveying belt 14 disposed in the belt conveying portion 13. Then, the toner image is heat-fixed onto the recording material 19 by the fixing device 15.

After that, the recording material 19 is guided to the conveyance path 37a by rotating the flapper 38 and is straightly discharged to the outside of the main body of the image forming apparatus 27 by the discharge roller 24a, or the recording material 19 is delivered to the post treatment device (not illustrated) and is subjected to a predetermined post treatment, and then, a duplex printing operation is ended. Thus, the straight discharge, the reversing discharge, and the duplex printing can be arbitrarily set according to the printing job.

<Configuration between Transfer Portion and Fixing Portion>

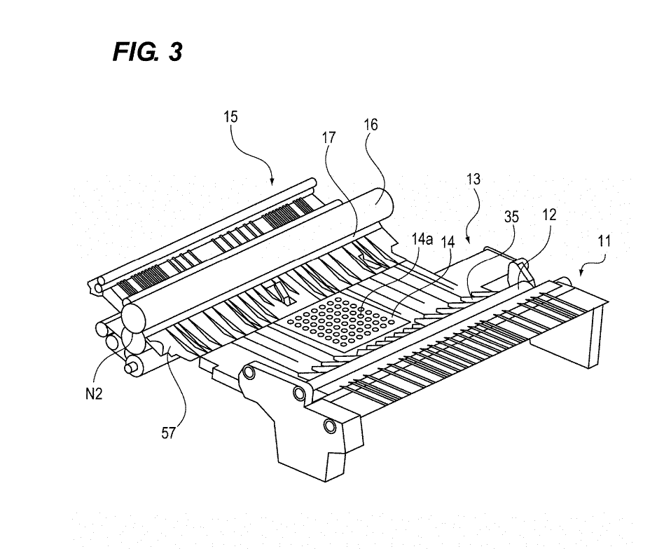

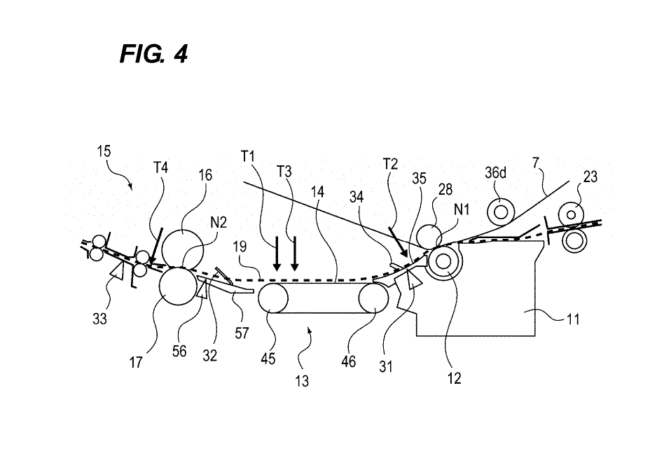

Next, a configuration between the transfer portion and the fixing portion will be described by using FIG. 3 and FIG. 4. FIG. 3 is a perspective explanatory diagram illustrating the configuration between the transfer portion and the fixing portion. FIG. 4 is a sectional explanatory diagram illustrating the configuration between the transfer portion and the fixing portion. In FIG. 4, the post-transfer sensor 31, which becomes a sensing portion sensing the recording material 19, disposed between the secondary transfer portion 11 (the transfer portion) and the belt conveying portion 13, is provided.

The fixing inlet sensor 56 is provided. The post-fixing sensor 33 is provided. The loop amount sensing sensor 34, which becomes a loop sensing portion sensing a loop amount of the recording material 19, disposed between the secondary transfer portion 11 (the transfer portion) and the fixing device 15 (the fixing portion), is provided.

### <Neutralizing Plate>

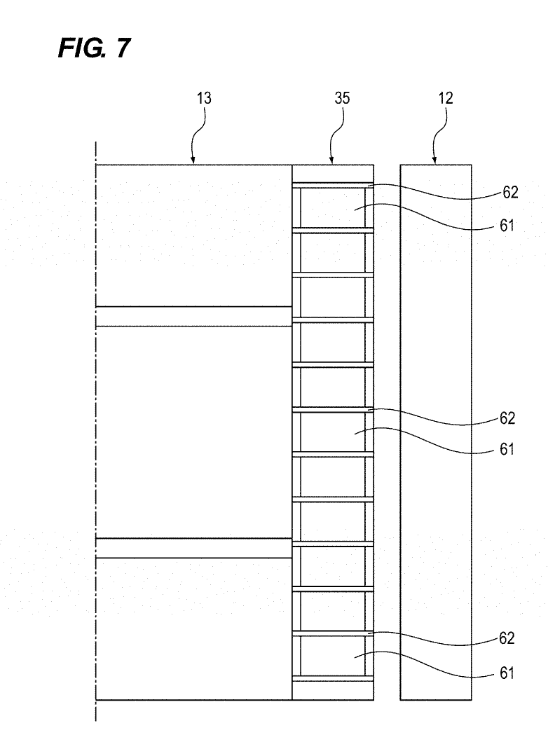

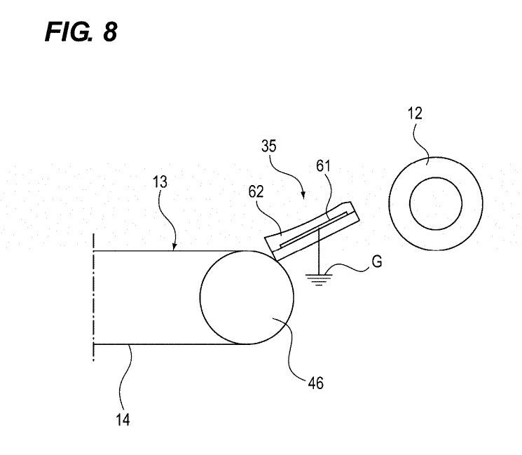

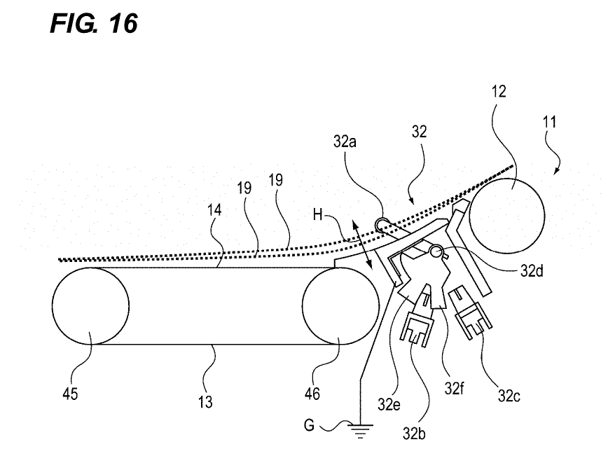

Next, a configuration of a neutralizing plate, which becomes a neutralizing portion, will be described by using FIG. 7 and FIG. 8. FIG. 7 is a plan explanatory diagram illustrating the configuration of the neutralizing plate. FIG. 8 is a sectional explanatory diagram illustrating the configuration of the neutralizing plate. In FIG. 7 and FIG. 8, a post-transfer guide 35, which becomes a conveyance guide disposed between the secondary transfer portion 11 (the transfer portion) and the belt conveying portion 13, is provided. The post-transfer guide 35 (the conveyance guide) includes a metal neutralizing plate 61 having conductivity, which becomes a neutralizing portion of the recording material 19. As illustrated in FIG. 16, the neutralizing plate 61 is grounded G on a conductive frame of the image forming apparatus 27. The neutralizing plate 61 is disposed between conveying ribs 62 which are erected on the post-transfer guide 35.

The toner image borne on the outer circumferential surface of the intermediate transfer belt 7 is secondarily transferred onto the recording material 19 at the time of performing secondary transfer. At this time, the secondary transfer bias voltage is applied to secondary transfer roller 12 from the secondary transfer bias power source (not illustrated), and the recording material 19 is charged. The recording material 19 electrically charged is slidably conveyed on the conveying rib 62 which is erected on the post-transfer guide 35. In such a procedure, the neutralizing plate 61 which is grounded G is neutralized by arc discharge. Furthermore, the neutralizing plate 61 may be neutralized by being electrically in contact with the recording material 19 to be conveyed.

Furthermore, a neutralizing cloth having conductivity may be used instead of the metal neutralizing plate 61 having conductivity. In addition, a charge removal needle having conductivity may be additionally disposed between the secondary transfer roller 12 and the post-transfer guide 35 (the conveyance guide) provided with the neutralizing plate 61, and the charge removal needle may be neutralized by being electrically in contact with the recording material 19 to be conveyed.

Timing positions T1 to T4 illustrated in FIG. 4 indicate positions where the conveyance velocity V of the recording material 19 which is conveyed between the secondary transfer portion 11 (the transfer portion), the belt conveying portion 13, and fixing device 15 (the fixing portion) is controlled. The post-transfer sensor 31, the fixing inlet sensor 56, and the post-fixing sensor 33 are each sensing portions sensing the passing of the recording material 19 to be conveyed.

The loop amount sensing sensor 34 is the following sensing portion. A rear end portion of the recording material 19 in the traveling direction (a left direction of FIG. 4) is nipped and conveyed by the outer circumferential surface of the intermediate transfer belt 7 and the secondary transfer roller 12 in the secondary transfer portion 11. Then, a front end portion of the recording material 19 in the traveling direction (the left direction of FIG. 4) is nipped and conveyed by the fixing roller 16 and the pressure roller 17 of the fixing device 15. At this time, a sensing portion sensing a loop height H of a loop which is generated in the recording material 19 in a lower direction of FIG. 4.

The CPU 49, which becomes the controller, controls a rotation velocity of the pressure roller 17 by driving and controlling the fixing motor 52 through the input/output device (I/O) 50, on the basis of a sensing result of the loop amount sensing sensor 34. The fixing roller 16 rotated following the rotation of the pressure roller 17. Accordingly, the conveyance velocity V of the recording material 19 in the fixing device 15 is controlled.

The post-transfer guide 35 is a guide delivering the recording material 19 from the secondary transfer nip portion N1, which is formed of the secondary transfer roller 12 and the outer circumferential surface of the intermediate transfer belt 7, to the conveying belt 14. An earth plate (not illustrated) disposed in the post-transfer guide 35 is as follow. The secondary transfer bias voltage formed of a high voltage is applied to the secondary transfer roller 12, and the toner image borne on the outer circumferential surface of the intermediate transfer belt 7 is secondarily transferred onto the recording material 19. At this time, the earth plate having conductivity is in contact with the charged recording material 19, and thus, the recording material 19 is delivered to the conveying belt 14 while being neutralized during the conveyance of the recording material 19.

### <Belt Conveying Portion>

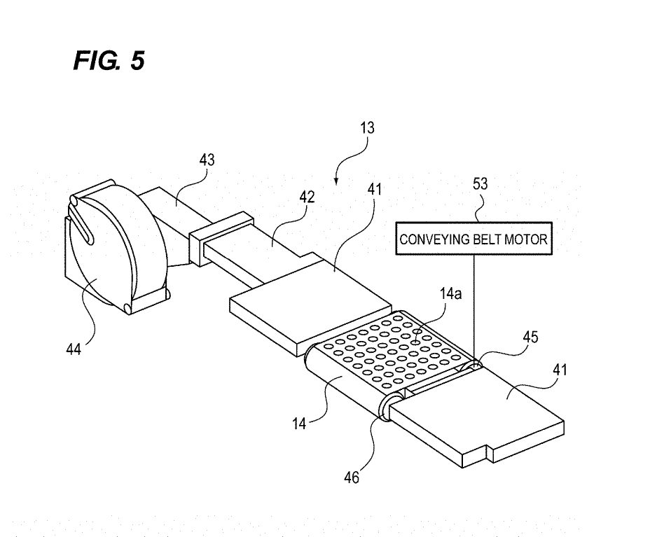

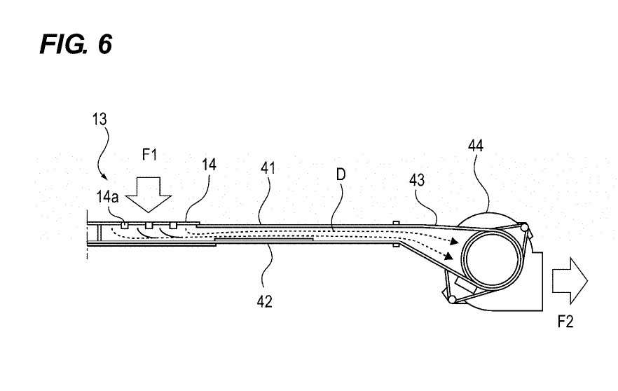

Next, a configuration of the belt conveying portion 13 will be described by using FIG. 5 and FIG. 6. FIG. 5 is a perspective explanatory diagram illustrating the configuration of the belt conveying portion. FIG. 6 is a sectional explanatory diagram illustrating the configuration of the belt conveying portion. In FIG. 5 and FIG. 6, the conveying belt 14 is provided. A conveyance guide 41 is provided. A lower cover 42 is provided. A connecting duct 43 is provided. A suction fan 44 is provided. A driving roller 45 rotatively driving the conveying belt 14 is provided. A driven roller 46 is provided. The conveying belt 14 is stretched by the driving roller 45 and the driven roller 46, and is rotatively driven.

As illustrated in FIG. 5, the belt conveying portion 13 includes the conveying belt 14 in the center portion (a part) of the conveyance guide 41. The conveying belt 14 is supported by being stretched at a predetermined tensile force by the driving roller 45 and the driven roller 46 which are arranged at a predetermined pitch. The CPU 49 drives and controls the conveying belt motor 53 through the input/output device (I/O) 50, and rotatively drives the driving roller 45 through a drive transmission portion (not illustrated) such as a gear or a timing belt. The conveying belt 14 is friction-conveyed and rotated according to the rotation of the driving roller 45. A plurality of through holes 14a is disposed on a front surface of the conveying belt 14.

As illustrated in FIG. 6, the lower cover 42 is disposed on a lower side of the conveyance guide 41, and a duct is formed by being integrated with the conveyance guide 41. The duct is communicated with an inner circumferential portion of the conveying belt 14. In addition, the duct is communicated with the inside of the connecting duct 43. Then, a flow D of air is formed in the order of the inner circumferential portion of the conveying belt 14, the duct formed of the conveyance guide 41 and the lower cover 42, and the connecting duct 43 from the through hole 14a disposed on the front surface of the conveying belt 14, according to the rotation of the suction fan 44. The recording material 19 on the conveying belt 14 is conveyed in the left direction of FIG. 4 while being sucked by a suction force from the plurality of through holes 14a in the direction of an arrow F1 of FIG. 6, according to the flow D of the air.

The air sucked in the direction of the arrow F1 of FIG. 6 is discharged in the direction of an arrow F2 of FIG. 6 through the conveying belt 14, the duct formed of the conveyance guide 41 and the lower cover 42, and the connecting duct 43. After that, the air converges on a main body duct (not illustrated) disposed in the main body of the image forming apparatus 27, and is discharged to the outside of the main body of the image forming apparatus 27 through a filter.

The configuration of the conveying belt 14 and the conveyance guide 41 is not limited to the configuration illustrated in FIG. 5 and FIG. 6, and may include a plurality of conveying belts 14 and a plurality of conveyance guides 41. In addition, the configuration forming the flow D of the air is also not limited to the configuration illustrated in FIG. 6, and for example, one or more axial flow fans may be disposed immediately under the conveying belt 14, and may directly suck the recording material 19 without using the duct.

### <Conveyance Velocity of Recording Material>

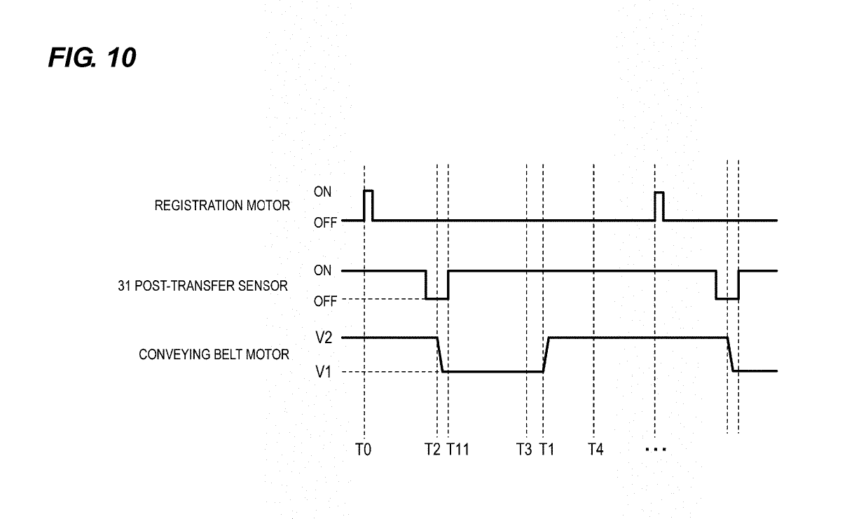

Next, the control of the conveyance velocity of the recording material in the conveying belt will be described by using FIG. 10. FIG. 10 is a timing chart diagram illustrating the control of the variable velocity of the conveying belt. In FIG. 10, the registration roller 23 illustrated in FIG. 1 feeds the recording material 19 to the secondary transfer nip portion N1 in synchronization with the exposure of the laser scanner 1. A timing T0 is set to a timing where the registration motor 54 which is driven and controlled by the CPU 49 through the input/output device (I/O) 50 is turned ON.

In the first sheet of the printing job, the conveying belt motor 53 is driven and controlled by the CPU 49 through the input/output device (I/O) 50 at the timing T0 where the registration motor 54 is turned ON, and the driving roller 45 is rotatively driven. Accordingly, the conveyance velocity V of the recording material 19 in the conveying belt 14 is activated at a first velocity V1 (300 mm/sec) illustrated in FIG. 10. The first velocity V1 (300 mm/sec) is the conveyance velocity V of the recording material 19 in the belt conveying portion 13 when the belt conveying portion 13 receives the front end portion of the recording material 19 in the traveling direction (the left direction of FIG. 4) from the secondary transfer portion 11 (the transfer portion).

That is, the conveyance velocity V of the recording material 19 in the belt conveying portion 13 is set to the first velocity V1 (300 mm/sec) before the front end portion of the recording material 19 in the traveling direction (the left direction of FIG. 4) reaches the conveying belt 14 (the surface of the conveying belt) of the belt conveying portion 13.

The first velocity V1 (300 mm/sec), which becomes the conveyance velocity V of the recording material 19 in the conveying belt 14, is set to a velocity which is approximately identical to a moving velocity of the outer circumferential surface of the intermediate transfer belt 7. The recording material 19 passing through the secondary transfer nip portion N1 is sensed by the post-transfer sensor 31, and the post-transfer sensor 31 is turned ON at a timing T11. Furthermore, in the first sheet of the printing job, the post-transfer sensor 31 is started from a state of OFF illustrated by a broken line in FIG. 10.

The conveyance velocity V of the recording material 19 in the conveying belt 14 varies to a second velocity V2 (306 mm/sec) at a timing T1 illustrated in FIG. 10. The second velocity V2 (306 mm/sec) is the conveyance velocity V of the recording material 19 in the belt conveying portion 13 before the rear end portion of the recording material 19 in the traveling direction leaves the secondary transfer portion 11 (the transfer portion) when the belt conveying portion 13 delivers the front end portion of the recording material 19 in the traveling direction (the left direction of FIG. 4) to the fixing device 15 (the fixing portion). The second velocity V2 (306 mm/sec) is faster than the first velocity V1 (300 mm/sec).

The timing T1 illustrated in FIG. 4 and FIG. 10 is a timing where the front end portion of the recording material 19 in the traveling direction (the left direction of FIG. 4) illustrated in FIG. 4 reaches a position immediately before leaving the conveying belt 14. At the timing T1, the conveyance velocity V of the recording material 19 in the conveying belt 14 is changed from the first velocity V1 (300 mm/sec) to the second velocity V2 (306 mm/sec) which is faster than the first velocity V1, and the recording material 19 is delivered from the conveying belt 14 to the fixing device 15.

That is, the conveyance velocity V of the recording material 19 in the belt conveying portion 13 is controlled as follow. The front end portion of the recording material 19 in the traveling direction (the left direction of FIG. 4) reaches the fixing nip portion N2 of the fixing device 15 (the fixing portion). Before such a timing, the conveyance velocity V is set by being changed from the first velocity V1 (300 mm/sec) to the second velocity V2 (306 mm/sec) which is faster than the first velocity V1.

The belt conveying portion 13 delivers the front end portion of the recording material 19 in the traveling direction (the left direction of FIG. 4) to the fixing device 15 (the fixing portion). At this time, the second velocity V2 (306 mm/sec), which becomes the conveyance velocity V of the recording material 19 in the belt conveying portion 13, is faster than an initially set conveyance velocity V10 (297 mm/sec to 300 mm/sec) of the recording material 19 in the fixing device 15 (the fixing portion).

In addition, the second velocity V2 (306 mm/sec) is faster than the first velocity V1 (300 mm/sec), which becomes the conveyance velocity V of the recording material 19 in the secondary transfer portion 11 (the transfer portion). In addition, the initially set conveyance velocity V10 (297 mm/sec to 300 mm/sec) of the recording material 19 in the fixing device 15 (the fixing portion) is less than or equal to the first velocity V1 (300 mm/sec), which becomes the conveyance velocity V of the recording material 19 in the secondary transfer portion 11 (the transfer portion), (less than or equal to the conveyance velocity).

The fixing device 15 is operated by the pressure roller 17 which is rotatively driven by the fixing motor 52, by the CPU 49 illustrated in FIG. 2 through the input/output device (I/O) 50. Then, a conveyance velocity Vf (297 mm/sec to 300 mm/sec) of the recording material 19 in the fixing device 15 is set to a velocity which is identical to or slower than the first velocity V1 (300 mm/sec), which becomes the conveyance velocity V of the recording material 19 in the secondary transfer portion 11. Accordingly, the velocity is set such that the recording material 19 is not pulled between the secondary transfer portion 11 and the fixing device 15 (the fixing portion).

After the second sheet of the printing job, the timing T0 where the registration motor 54, which is driven and controlled by the CPU 49 through the input/output device (I/O) 50, is turned ON, is set as an origination. Then, the driving roller 45 is rotatively driven by the conveying belt motor 53 which is driven and controlled by the CPU 49 through the input/output device (I/O) 50, at a timing T2 (T2>T0). Then, the conveyance velocity V of the recording material 19 in the conveying belt 14 is returned to the first velocity V1 (300 mm/sec).

The timing T2 is set to a timing where the front end portion of the recording material 19 in the traveling direction (the left direction of FIG. 4) illustrated in FIG. 4 reaches a position immediately before reaching the conveying belt 14. After that, the conveyance velocity V of the recording material 19 in the conveying belt 14 repeatedly varies at the timing T1 and the timing T2 by setting the timing T0 where the registration motor 54 is turned ON, as the origination. The CPU 49 determines that it is the timing T1 at a predetermined time after the registration motor 54 is turned ON (T0).

As for the timing T2, the CPU 49 determines that it is the timing T2 at a predetermined time after the registration motor 54 is turned ON (T0). Furthermore, the timings T1 and T2 may be determined on the basis of a signal from a sensor sensing the recording material 19 instead of determining the timings T1 and T2 on the basis of ON of the registration motor 54. For example, the CPU 49 may determine that it is the timing T1 on the basis of the sensing of the recording material 19 in the post-transfer sensor 31. Specifically, the CPU 49 determines that it is the timing T1 after a predetermined time from the sensing of the recording material 19 in the post-transfer sensor 31.

The post-transfer sensor 31, which becomes the sensing portion, senses an uplift of the recording material 19 passing through the secondary transfer portion 11 (the transfer portion) or the winding of the recording material 19 with respect to the outer circumferential surface of the intermediate transfer belt 7 in the secondary transfer portion 11 (the transfer portion). A timing T3 illustrated in FIG. 4 and FIG. 10 is a timing where it is sensed whether or not the uplift of the recording material 19 or the winding of the recording material 19 with respect to the outer circumferential surface of the intermediate transfer belt 7 occurs from the sensing result of the recording material 19 in the post-transfer sensor 31.

A case is considered in which the recording material 19 passing through the secondary transfer nip portion N1 of the secondary transfer portion 11 (the transfer portion) floats or is wound by being electrostatically attached to the outer circumferential surface of the intermediate transfer belt 7. In this case, the recording material 19 is not capable of being introduced to the fixing nip portion N2 of the fixing roller 16 and the pressure roller 17 of the fixing device 15 in a straight state, and thus, a conveyance failure occurs. For this reason, the CPU 49 confirms that the post-transfer sensor 31 maintains the state of ON at the timing T3 illustrated in FIG. 4 and FIG. 10.

Thus, the recording material 19 passes through the secondary transfer nip portion N1 of the secondary transfer portion 11. After that, the winding of the recording material 19 with respect to the outer circumferential surface of the intermediate transfer belt 7 is sensed. In such a case, a case is considered in which the conveyance velocity V of the recording material 19 in the conveying belt 14 is faster than the moving velocity of the intermediate transfer belt 7. As a result thereof, there is a concern that the winding of the recording material 19 with respect to the outer circumferential surface of the intermediate transfer belt 7 is not capable of being normally sensed. For this reason, a variable velocity timing T1 of the conveyance velocity V of the recording material 19 in the conveying belt 14 may be slower than the timing T3.

That is, in this embodiment, the conveyance velocity V of the recording material 19 in the belt conveying portion 13 is controlled as follow. The front end portion of the recording material 19 in the traveling direction (the left direction of FIG. 4) is controlled as follow before reaching the fixing nip portion N2 of the fixing device 15 (the fixing portion). The velocity is set by being changed from the first velocity V1 (300 mm/sec) to the second velocity V2 (306 mm/sec) after the sensing of the recording material 19 in the post-transfer sensor 31 (the sensing portion) is ended.

A timing T4 illustrated in FIG. 4 and FIG. 10 is a start timing of the control of the loop amount. When the recording material 19 is conveyed across the secondary transfer portion 11 and the fixing device 15, the pulling or an excessive loop of the recording material 19 occurs. As a result thereof, the behavior of the recording material 19 becomes unstable, and thus, a jam occurs, or the recording material 19 is skew-fed and turned. Accordingly, an image position is shifted, or the impact or the vibration is imparted to the secondary transfer portion 11 or the image forming portion 55 positioned on the upstream of the secondary transfer portion 11, and thus, there is case where image blurring or a color shift occurs.

For this reason, the CPU 49 performs control as follow such that the loop amount of the recording material 19 formed between the secondary transfer portion 11 and the fixing device 15 becomes proper. The fixing motor 52 is driven and controlled on the basis of the sensing result of the loop amount of the recording material 19 sensed by the loop amount sensing sensors 32 and 34, which becomes the loop sensing portion, and the rotative driving of the pressure roller 17 is controlled. Accordingly, the conveyance velocity V of the recording material 19 in the fixing device 15 is controlled.

There is no problem in considering the control of the loop amount of the recording material 19 independent from the control of the variable velocity of the conveying belt 14. That is, the conveyance velocity V of the recording material 19 in the belt conveying portion 13 is controlled as follow at the same time as the sensing of the loop amount of the recording material 19 in the loop amount sensing sensors 32 and 34(loop sensing portion) is started or after the sensing of the loop amount is started. The velocity is changed from the first velocity V1 (300 mm/sec) to the second velocity V2 (306 mm/sec).

<Object and Effect between Transfer Portion and Fixing Portion>

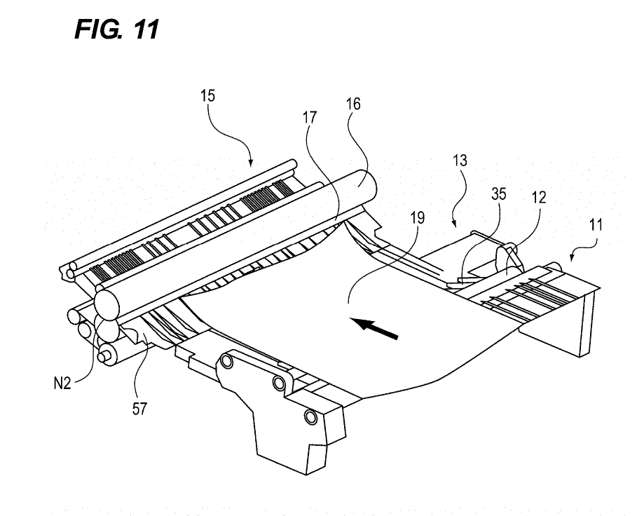

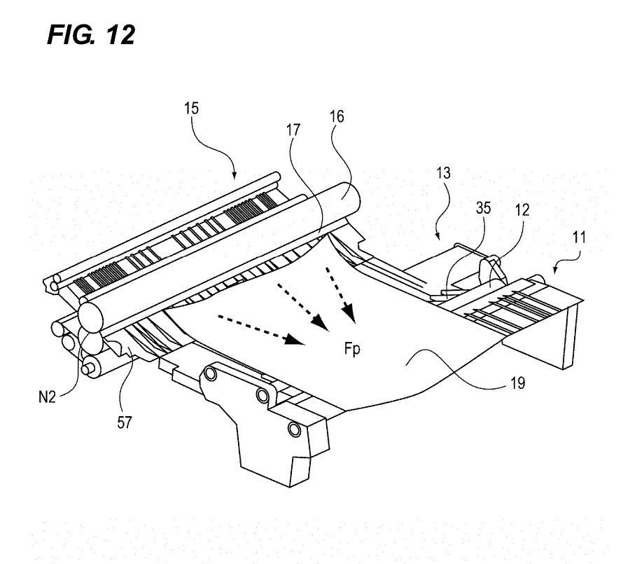

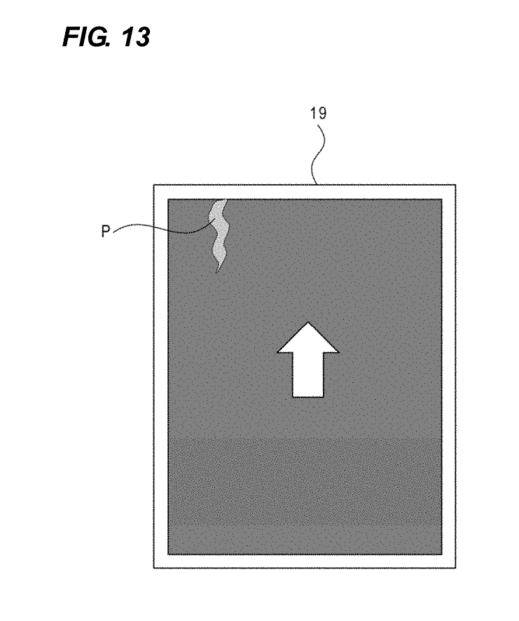

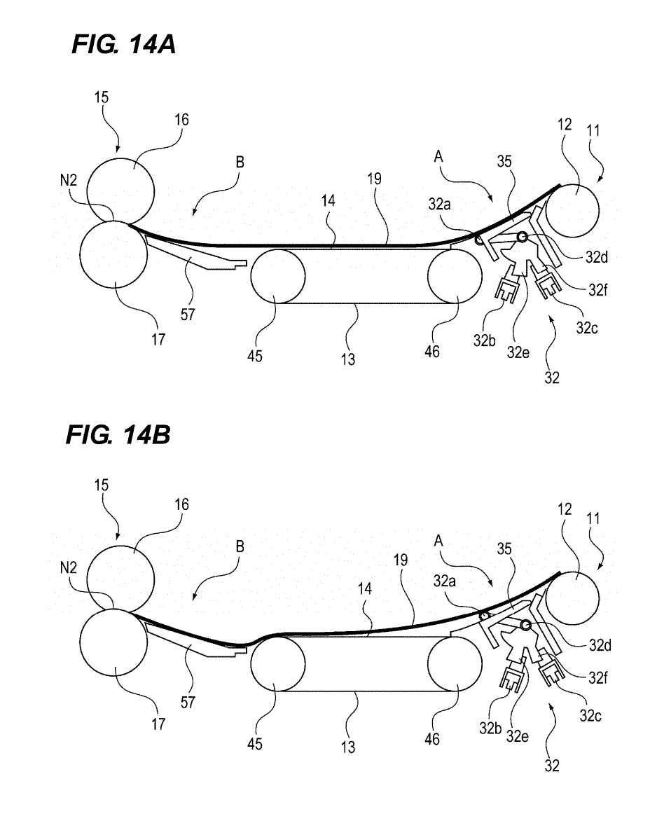

Next, FIG. 3, an object and an effect between the transfer portion and the fixing portion will be described by using FIG. 11 to FIG. 14B. FIG. 3 is a perspective explanatory diagram illustrating a configuration between the transfer portion and the fixing portion. FIG. 11 is a perspective explanatory diagram illustrating a mechanism in which an image disturbance or a wrinkle, a breakage, or the like occurs in the fixing nip portion. FIG. 12 is a perspective explanatory diagram illustrating the mechanism in which the image disturbance, the wrinkle, the breakage, or the like occurs in the fixing nip portion. FIG. 13 is a plan explanatory diagram illustrating an example in which an image disturbance occurs. FIG. 14A is a sectional explanatory diagram illustrating the behavior of a recording material at the time of performing the control of the variable velocity of the conveying belt. FIG. 14B is a sectional explanatory diagram illustrating the behavior of the recording material at the time of performing the control of the variable velocity of the conveying belt.

In FIG. 3, for the sake of the convenience of the description, the intermediate transfer belt 7 is omitted. The secondary transfer roller 12, the fixing roller 16, the pressure roller 17, the fixing nip portion N2, and the conveying belt 14 between the secondary transfer roller 12 and the fixing nip portion N2 are illustrated in FIG. 3. As illustrated in FIG. 11, the recording material 19 is conveyed from the secondary transfer portion 11 towards the fixing device 15, between the secondary transfer portion 11 and the fixing device 15 illustrated in FIG. 3. At this time, in a case where corrugation or curling is formed in a direction which is orthogonal to a direction where the recording material 19 is conveyed, there is a case where the recording material 19 is not introduced to the fixing nip portion N2 of the fixing roller 16 and the pressure roller 17 in the straight state.

As illustrated in FIG. 11, in a case where the recording material 19 is conveyed to the fixing nip portion N2 of the fixing roller 16 and the pressure roller 17 in a corrugated state, the unfixed toner image on the recording material 19 is partially disturbed on a front surface of the fixing roller 16 immediately before the fixing nip portion N2. As a result thereof, an image defect, such as an image disturbance P as illustrated in FIG. 13, occurs.

In a case where the corrugation or the curling of the recording material 19 further increases, there is a case where a wrinkle, a breakage, or the like occurs on the recording material 19. A problem such as the image disturbance P, the breakage, the wrinkle, or the like due to the corrugation or the curling of the recording material 19 occurs according to a condition such as a basis weight, the thickness, a sheet fiber (a fiber in a flow direction, which is generated at the time of making a sheet), the stiffness, the unevenness in a moisture amount of the recording material 19. The problem easily occurs as a sheet is thin and has low stiffness, and tends to easily occur as the environment is in the high temperature and high humidity.

In addition, as illustrated in FIG. 12, the recording material 19 has the following behavior from the moment where the recording material 19 enters the fixing nip portion N2 of the fixing roller 16 and the pressure roller 17 and immediately after the recording material 19 enters the fixing nip portion N2. The recording material 19 is pulled between the conveying belt 14 and the fixing device 15 due to a suction force Fp of the recording material 19 in the conveying belt 14 which is disposed on the upstream side of the recording material 19 in the traveling direction (a left direction of FIG. 12) from the fixing nip portion N2. As a result thereof, the corrugation of the recording material 19 increases, and the image disturbance P, the breakage, the wrinkle, or the like more easily occurs.

In FIG. 14A, the recording material 19 is conveyed at the first velocity V1 (300 mm/sec) where the conveyance velocity V of the recording material 19 in the conveying belt 14 becomes the conveyance velocity V which is identical to or slower than the conveyance velocity V of the recording material 19 in the secondary transfer portion 11 or the fixing device 15. FIG. 14A illustrates the behavior of the recording material 19 of such as case. FIG. 14B illustrates the behavior of the recording material 19 of a case where the recording material 19 is conveyed at the second velocity V2 (306 mm/sec) where the conveyance velocity V of the recording material 19 in the conveying belt 14 becomes the conveyance velocity V which is identical to or faster than the conveyance velocity V of the recording material 19 in the secondary transfer portion 11 or the fixing device 15.

As illustrated in FIG. 14A, a case where the conveyance velocity V of the recording material 19 in the conveying belt 14 is V1 (300 mm/sec) is as follow. In an A portion illustrated in FIG. 14A, a curved loop is formed on the recording material 19 between the secondary transfer portion 11 and the conveying belt 14 along the post-transfer guide 35. On the other hand, in a B portion illustrated in FIG. 14A, no curved loop is formed on the recording material 19 between the conveying belt 14 and the fixing device 15, and thus, the recording material 19 is conveyed in a state where there is a gap between the recording material 19 and the pre-fixing guide 57.

In contrast, as illustrated in FIG. 14B, a case where the conveyance velocity V of the recording material 19 in the conveying belt 14 is the second velocity V2 (306 mm/sec) is as follow. In an A portion illustrated in FIG. 14B, no curved loop is formed on the recording material 19 between the secondary transfer portion 11 and the conveying belt 14. Then, the recording material 19 is conveyed in a state where there is a gap between the recording material 19 and the post-transfer guide 35. On the other hand, in a B portion illustrated in FIG. 14B, a curved loop is formed on the recording material 19 between the conveying belt 14 and the fixing device 15 along the pre-fixing guide 57.

In the problem, such as the image disturbance P, occurring in the fixing nip portion N2 of the fixing roller 16 and the pressure roller 17 of the fixing device 15, as illustrated in FIG. 14B, a state is desirable in which the loop is formed on the recording material 19 between the conveying belt 14 and the fixing device 15. The recording material 19 is guided to the fixing nip portion N2 of the fixing device 15 from a lower side along the pre-fixing guide 57. Accordingly, it is possible to prevent the image disturbance P due to friction by increasing a distance between the recording material 19 and the fixing roller 16.

In addition, the recording material 19 is guided to the fixing nip portion N2 of the fixing roller 16 and the pressure roller 17 along the pre-fixing guide 57 which is disposed immediately before the fixing device 15. Accordingly, it is possible to deliver the recording material 19 to the fixing nip portion N2 while reducing the influence of the corrugation formed on the recording material 19.

Further, a sufficient loop is formed on the recording material 19 between the conveying belt 14 and the fixing device 15, and thus, it is difficult for the recording material 19 to be affected by the conveying belt 14 immediately after being introduced to the fixing nip portion N2 of the fixing roller 16 and the pressure roller 17. For this reason, it is possible to suppress the occurrence of the image disturbance P, the wrinkle, the breakage, or the like on the recording material 19.

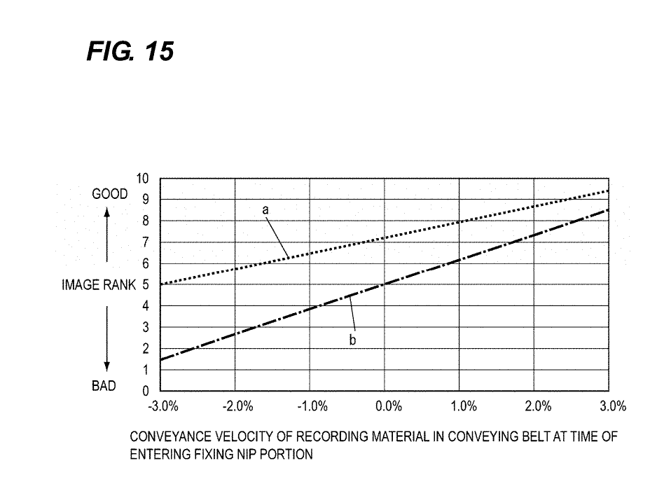

FIG. 15 is a diagram illustrating an effect of suppressing the image disturbance P at the time of performing the control of the variable velocity of the conveying belt 14. In FIG. 15, a horizontal axis represents an increasing or decreasing rate with respect to the second velocity V2 (306 mm/sec), which becomes the conveyance velocity V of the recording material 19 in the conveying belt 14. 0.0% described on the center of the horizontal axis is 306 mm/sec. A left side of the horizontal axis represents deceleration, and a right side of the horizontal axis represents acceleration. FIG. 15 illustrates a relationship between the conveyance velocity V of the recording material 19 in the conveying belt 14 and the image disturbance P at the time of using two types of thin sheets a and b.

As illustrated in FIG. 15, when the recording material 19 is delivered to the fixing device 15 from the conveying belt 14, the second velocity V2 (306 mm/sec), which becomes the conveyance velocity V of the recording material 19 in the conveying belt 14, is changed. As a result thereof, the loop amount on the recording material 19 between the conveying belt 14 and the fixing device 15 increases as the second velocity V2, which becomes the conveyance velocity V of the recording material 19 in the conveying belt 14, becomes faster, and thus, a result is obtained in which the level of the image disturbance P is released.

On the other hand, when the recording material 19 is delivered from the secondary transfer portion 11 to the conveying belt 14, as illustrated in the A portion of FIG. 14A, a state is desirable in which the loop is formed on the recording material 19 between the secondary transfer portion 11 and the conveying belt 14. As illustrated in FIG. 4, the recording material 19 passing the secondary transfer nip portion N1 is conveyed along the post-transfer guide 35 including the neutralizing portion (not illustrated).

Accordingly, a front end side of the recording material 19 in the traveling direction is reliably neutralized, and thus, the occurrence of electrostatic flapping or floating is suppressed. In such a state, a downstream side (a left side of FIG. 4) of the recording material 19 in the traveling direction can be delivered to the conveying belt 14 or the fixing device 15. Accordingly, when the downstream side of the recording material 19 is delivered to the fixing device 15, the flapping or the floating of the recording material 19 rarely occurs. For this reason, it is possible to suppress the occurrence of the image disturbance P, the wrinkle, the breakage, or the like.

For this reason, when the recording material 19 is delivered from the conveying belt 14 to the fixing device 15, the second velocity V2 (306 mm/sec), which becomes the conveyance velocity V of the recording material 19 in the conveying belt 14, may be set to a fast velocity. In addition, when the recording material 19 is delivered from the secondary transfer portion 11 to the conveying belt 14, the first velocity V1 (300 mm/sec), which becomes the conveyance velocity V of the recording material 19 in the secondary transfer portion 11, may be set to a slow velocity. Accordingly, the second velocity V2 (306 mm/sec) is faster than first velocity V1 (300 mm/sec).

In an electrostatic uplift of the recording material 19 passing the secondary transfer portion 11 or the winding of the recording material 19 with respect to the outer circumferential surface of the intermediate transfer belt 7, the post-transfer sensor 31 illustrated in FIG. 4 senses the front end portion of the recording material 19 in the traveling direction. After that, at the timing T3 after a predetermined time elapses, there is a case where it is confirmed that the state of the post-transfer sensor 31 is not changed. In such a case, the timing T1 where the conveyance velocity V of the recording material 19 in the conveying belt 14 varies to the second velocity V2 (306 mm/sec) is the following timing. A timing after the timing T3 where the electrostatic uplift of the recording material 19 passing the secondary transfer portion 11 or the winding of the recording material 19 with respect to the outer circumferential surface of the intermediate transfer belt 7 is sensed is desirable.

As illustrated in FIG. 14B, the following case is considered at the timing T3 where the electrostatic uplift of the recording material 19 passing the secondary transfer portion 11 or the winding of the recording material 19 with respect to the outer circumferential surface of the intermediate transfer belt 7 is sensed. For example, a case is considered in which the conveyance velocity V of the recording material 19 in the conveying belt 14 is set to the second velocity V2 (306 mm/sec). As a result thereof, there is no loop on the recording material 19 between the secondary transfer portion 11 and the conveying belt 14, and thus, the distance between the post-transfer sensor 31 and the recording material 19 increases to be greater than or equal to a predetermined amount. In this case, the post-transfer sensor 31 is in the state of OFF, and thus, there is a concern that a sensing error occurs.

For example, in a case where the post-transfer sensor 31 is a non-contact type sensor, a rear surface of an image printing surface of the recording material 19 is black or in a case where the first surface at the time of performing duplex printing is a black image, a range where the sensing of the post-transfer sensor 31 can be performed, and thus, a sensing error easily occurs. In order to avoid such a problem, when the recording material 19 is delivered from the conveying belt 14 to the fixing device 15, the second velocity V2 (306 mm/sec), which becomes the conveyance velocity V of the recording material 19 in the conveying belt 14, is set to a fast velocity. In addition, when the recording material 19 is delivered from the secondary transfer portion 11 to the conveying belt 14, the first velocity V1 (300 mm/sec), which becomes the conveyance velocity V of the recording material 19 in the secondary transfer portion 11, is set to a slow velocity.

Further, the recording material 19 passes through the secondary transfer portion 11, and then, the winding of the recording material 19 with respect to the outer circumferential surface of the intermediate transfer belt 7 or the electrostatic uplift of the recording material 19 is sensed by the post-transfer sensor 31. In this case, the conveyance velocity V of the recording material 19 in the conveying belt 14 may change to the second velocity V2 (306 mm/sec) after the sense timing T3.

In the loop formed on the recording material 19 between the conveying belt 14 and the fixing device 15, the conveyance velocity V of the fixing device 15 is greatly changed according to an increase in a temperature. For this reason, the fixing device 15 includes a sensing portion of the conveyance velocity V and a sensing portion of the temperature, and on the basis of the sensing result, a setting value of the second velocity V2, which becomes the conveyance velocity V of the recording material 19 in the conveying belt 14 can be changed.

In addition, the setting value of the second velocity V2, which becomes the conveyance velocity V of the recording material 19 in the conveying belt 14, may be changed according to a temperature and humidity condition of an installation environment of the image forming apparatus 27, the basis weight, the thickness, and the moisture amount of the recording material 19.

That is, basis weight data of the recording material 19 to be used is stored in advance in the memory 59, which becomes a storage portion, in association with a printing mode to be selected by the user. Then, when the front end portion of the recording material 19 in the traveling direction is delivered from the belt conveying portion 13 to the fixing device 15 (the fixing portion) according to the basis weight data of the recording material 19 which is used according to the printing mode, the setting value of the second velocity V2 may be changed.

The basis weight of the recording material 19 can be obtained by the CPU 49 of the image forming apparatus 27 according to user input (selection of the type of the recording material 19 to be used) from an operation portion. In a case where the basis weight of the recording material 19 is small, the second velocity V2 is set to a high velocity compared to a case where the basis weight is large. The second velocity V2 is changed to the high velocity, and thus, the occurrence of the wrinkle of the recording material 19, which is prevented, is remarkable on a thin sheet (a sheet having a small basis weight). For example, in a case where the basis weight of the recording material 19 is large, the recording material 19 may enter the fixing nip portion N2 of the fixing device 15 (the fixing portion) from the conveying belt 14 at the first velocity V1 without changing the conveyance velocity V of the recording material 19 in the conveying belt 14 to the second velocity V2.

### <Control of Variable Velocity of Conveying Belt>

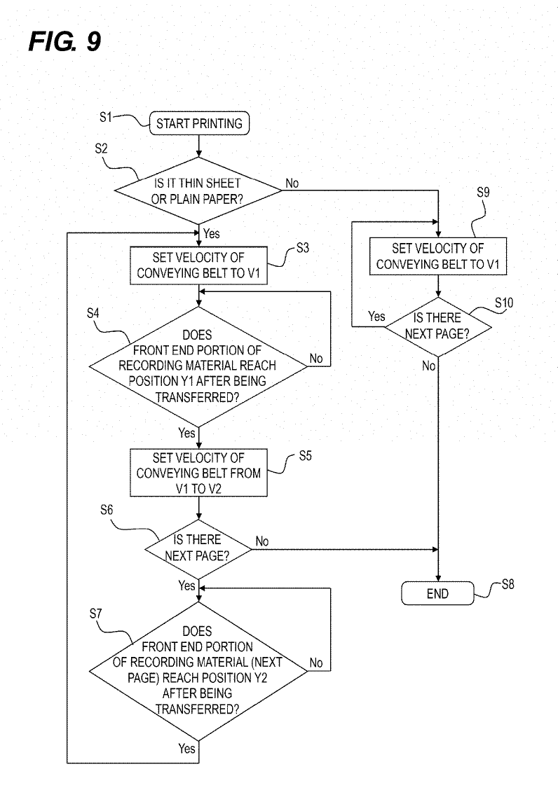

Next, the control of the variable velocity of the conveying belt 14 will be described by using FIG. 9. FIG. 9 is a flowchart illustrating the control of the variable velocity of the conveying belt. As illustrated in FIG. 9, in Step S1, in a case where the printing job is started, in Step S2, the CPU 49 confirms whether or not the recording material 19 used in the image forming apparatus 27 is set to a thin sheet or a plain paper, on the basis of the printing job set by the user.

In Step S2 described above, in a case where the recording material 19 to be used is the thin sheet or the plain paper, the process proceeds to Step S3. In Step S3 described above, the CPU 49 rotatively drives the driving roller 45 by driving and controlling the conveying belt motor 53 through the input/output device 50 (I/O), and the variable velocity is controlled by setting the conveyance velocity V of the recording material 19 in the conveying belt 14 to V1 (300 mm/sec).

The occurrence of the image disturbance P, the breakage, the wrinkle, and the like is greatly affected by the stiffness of the recording material 19. For this reason, the image disturbance P, the breakage, the wrinkle, or the like easily occurs as the recording material 19 becomes thinner. In addition, the image disturbance P, the breakage, the wrinkle, or the like tend to rarely occur as the recording material 19 becomes thicker.

In addition, in a case where the recording material 19 is a thick sheet or a coated paper (a sheet of which a front surface is coated with a coating material to increase an esthetic sense or smoothness), there is a concern that the image position is shifted or the impact occurs when the recording material 19 is pulled between the secondary transfer portion 11 and the conveying belt 14. For this reason, in this embodiment, only in a case where the recording material 19 is the thin sheet and the plain paper, the variable velocity of the conveying belt 14 is controlled.

That is, in Step S2 described above, in a case where the recording material 19 is the thick sheet or the coated paper, the process proceeds to Step S9. In Step S9 described above, the CPU 49 rotatively drives the driving roller 45 by driving and controlling the conveying belt motor 53 through input/output device 50 (I/O). Then, the conveyance velocity V of the recording material 19 in the conveying belt 14 is set to V1 (300 mm/sec). Then, the first velocity V1 (300 mm/sec), which becomes the conveyance velocity V of the recording material 19 in the conveying belt 14, is set to a fixed velocity until the printing job is ended.

After that, in Step S10, the CPU 49 determines whether or not it is the next page on the basis of the printing job set by the user, and in a case where there is the next page in the printing job of a plurality of pages, Steps S9 to S10 described above are repeated. In Step S10 described above, the printing job of all of the pages is ended, and then, the process proceeds to Step S8, and the CPU 49 ends the process.

In Step S2 described above, in a case where the recording material 19 is the thin sheet or the plain paper, the process proceeds to Step S3. In Step S3 described above, the CPU 49 rotatively drives the driving roller 45 by driving and controlling the conveying belt motor 53 through the input/output device 50 (I/O). Then, the conveyance velocity V of the recording material 19 in the conveying belt 14 is set to V1 (300 mm/sec).

After that, in Step S4, the front end portion of the recording material 19 in the traveling direction (the left direction of FIG. 4) passes through the secondary transfer nip portion N1 of the secondary transfer portion 11, and then, the CPU 49 determines whether or not the front end portion of the recording material 19 reaches a position Y1 (a position of 120 mm from the secondary transfer nip portion N1).

In Step S4 described above, in a case where the front end portion of the recording material 19 in the traveling direction reaches the position Y1, the process proceeds to Step S5. In Step S5 described above, the CPU 49 rotatively drives the driving roller 45 by driving and controlling the conveying belt motor 53 through the input/output device 50 (I/O). Then, the conveyance velocity V of the recording material 19 in the conveying belt 14 varies to the second velocity V2 (306 mm/sec) from V1 (300 mm/sec).

After that, in Step S6, in the case of the printing job of the plurality of pages, the CPU 49 determines that there is the next page, and the process proceeds to Step S7. In Step S7 described above, the front end portion of the recording material 19 in the traveling direction (the left direction of FIG. 4) after the next page passes through the secondary transfer nip portion N1 of the secondary transfer portion 11, and then, the CPU 49 determines whether or not the front end portion of the recording material 19 reaches a position Y2 (a position of 20 mm from the secondary transfer nip portion N1).

In Step S7 described above, the front end portion of the recording material 19 in the traveling direction (the left direction of FIG. 4) after the next page reaches the position Y2 (the position of 20 mm from the secondary transfer nip portion N1), and then, the process is returned to Step S3 described above. Then, in Step S3 described above, the CPU 49 rotatively drives the driving roller 45 by driving and controlling the conveying belt motor 53 through the input/output device 50 (I/O). Then, the conveyance velocity V of the recording material 19 in the conveying belt 14 is returned to V1 (300 mm/sec) from the second velocity V2 (306 mm/sec).

The control of the variable velocity of the conveyance velocity V of the recording material 19 in the conveying belt 14 in Steps S3 to S7 described above is repeated with respect to each of the pages. In Step S6 described above, the printing job of all of the pages is ended, and then, the process proceeds to Step S8, and the CPU 49 ends the process. Furthermore, the position Y1 in FIG. 9 corresponds to the timing T1 in FIG. 10. The position Y2 in FIG. 9 corresponds to the timing T2 in FIG. 10.

<Control of Loop of Recording Material between Transfer Portion and Fixing Portion>

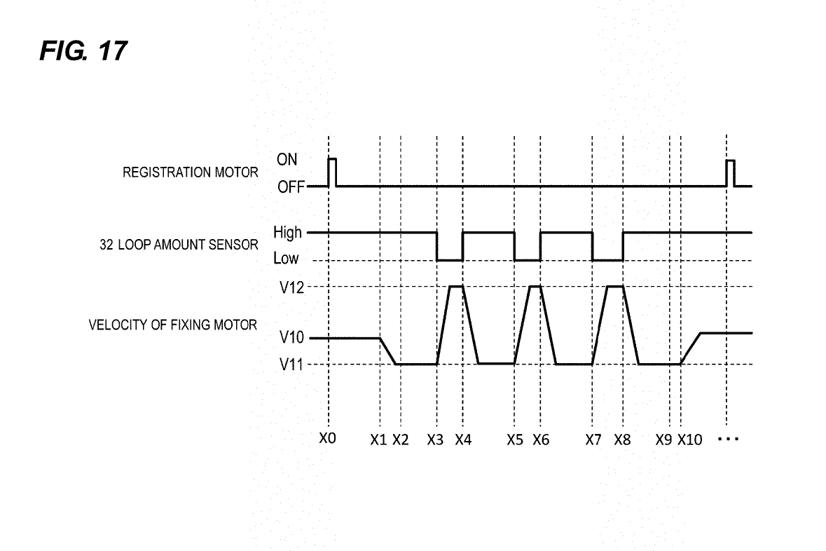

Next, the control of the loop of the recording material between the transfer portion and the fixing portion will be described by using FIG. 16 and FIG. 17. FIG. 16 is a sectional explanatory diagram illustrating a configuration of the sensor portion sensing the loop amount of the recording material between the conveying belt and the transfer portion. FIG. 17 is a timing chart diagram illustrating the control of the loop amount of the recording material.

In FIG. 16, a sensor flag 32a is slidable on the recording material 19 in order to sense the loop height H of the recording material 19. Photosensors 32b and 32c are provided. The loop height H represents the loop height of the recording material 19. The front end portion of the recording material 19 in the traveling direction (a left direction of FIG. 16) is conveyed for a predetermined distance from the fixing nip portion N2 of the fixing device 15 to the traveling direction (the left direction of FIG. 16), and then, the loop height H of the recording material 19 is sensed by the sensor flag 32a illustrated in FIG. 16.

The sensor flag 32a is rotatably supported on a support frame (not illustrated) of the post-transfer guide 35, which is disposed on the downstream of the recording material 19 of the secondary transfer portion 11 in the traveling direction, by using the rotation center 32d as the center. A lower surface of the recording material 19 slides on an upper portion of the sensor flag 32a, and thus, the sensor flag 32a is rotated around the rotation center 32d according to the loop height H of the recording material 19. Light shielding portions 32e and 32f, which are rotated around the rotation center 32d by being integrated with the sensor flag 32a, shield/transmit an optical path of each of the photosensors 32b and 32c, and changes an ON/OFF state of each of the photosensors 32b and 32c.

In this embodiment, the recording material 19 forms a convex loop on a lower side of FIG. 16. For this reason, the recording material 19 on the lower side of FIG. 16 is set to be in a state where the loop height H is high. In addition, the recording material 19 on an upper side of FIG. 16 is set to be in a state where the loop height H is low. In a case where the loop height H of the recording material 19 on the lower side of FIG. 16 becomes higher, the sensor flag 32a is rotated around the rotation center 32d in a counterclockwise direction of FIG. 16. Accordingly, the light shielding portions 32e and 32f shield the optical path of each of the photosensors 32b and 32c, and the photosensors 32b and 32c are set to be in the ON state.

In contrast, in a case where the loop height H of the recording material 19 on the upper side of FIG. 16 becomes lower, the sensor flag 32a is rotated around the rotation center 32d in a clockwise direction of FIG. 16. Accordingly, the light shielding portions 32e and 32f deviate from the optical path of the photosensors 32b and 32c, and the photosensors 32b and 32c are set to be in the OFF state.

In this embodiment, two photosensors of the photosensors 32b and 32c are used. In a case where the recording material 19 is the thin sheet or the plain paper, the loop amount of the recording material 19 is sensed by the photosensor 32c, and in a case where the recording material 19 is the thick sheet or the coated paper, the loop amount of the recording material 19 is sensed by the photosensor 32b.

The photosensor 32c senses the loop amount in which the loop height H of the recording material 19 on the lower side of FIG. 16 is high, and the photosensor 32b senses the loop amount in which the loop height H of the recording material 19 on the lower side of FIG. 16 is lower than that of the photosensor 32c. It is possible to change the height H of the loop amount of the recording material 19 which is controlled according to the environmental condition in which the image forming apparatus 27 is disposed or the type of the recording material 19.

For example, in a case where the recording material 19 is the thick sheet or the coated paper, there is a possibility that a loop reactive force due to the stiffness of the recording material 19 is imparted to the secondary transfer portion 11, and the image position is shifted or the impact occurs in the secondary transfer nip portion N1, in a case where the loop amount of the recording material 19 is excessively large. For this reason, the loop amount in which the loop height H of the recording material 19 on the lower side of FIG. 16 is low is sensed and controlled by the photosensor 32b.

In contrast, in a case where the recording material 19 is the thin sheet or the plain paper, the recording material 19 is conveyed along the post-transfer guide 35, and the flapping or the uplift of the recording material 19 is prevented, or the influence of the corrugation or the curling is reduced. For this reason, the loop amount in which the loop height H of the recording material 19 on the lower side of FIG. 16 is high is sensed and controlled by the photosensor 32c.

As illustrated in FIG. 17, the initial setting of the conveyance velocity V of the recording material 19 in the fixing device 15 is started at the conveyance velocity V10 (297 mm/sec to 300 mm/sec). The CPU 49 illustrated in FIG. 2 drives and controls the fixing motor 52 through the input/output device 50 (I/O), and rotatively drives the pressure roller 17 of the fixing device 15. Then, the secondary transfer portion 11 is set to a first velocity V11, which becomes the conveyance velocity V of the recording material 19 in the fixing device 15, at the position of a timing X1, by using a timing X0 where the registration motor 54 illustrated in FIG. 17 is turned ON as an origination.

The timing X1 is a timing immediately before the fixing device 15 receives the recording material 19. The timing X1 of this embodiment is a position of 10 mm on the upstream of the recording material 19 in the traveling direction from the fixing nip portion N2 of the fixing device 15. In addition, the first velocity V11, which becomes the conveyance velocity V of the recording material 19 in the fixing device 15, is 294 mm/sec.

After that, the control of the loop amount of the recording material 19 is started at a position of a timing X2. The timing X2 is a timing immediately after the fixing device 15 receives the recording material 19. In this embodiment, the timing X2 is a position of 5 mm on the downstream of the recording material 19 in the traveling direction from the fixing nip portion N2 of the fixing device 15.

The control of the loop amount of the recording material 19 is started by the CPU 49, and the loop amount sensing sensor 32 is changed from a High state to a Low state illustrated in FIG. 17, at timings X3, X5, and X7. As a result thereof, the conveyance velocity V of the recording material 19 in the fixing device 15 varies from V11 (294 mm/sec) to V12 (306 mm/sec).

Accordingly, the loop amount of the recording material 19 increases between the secondary transfer portion 11 and the fixing device 15. After that, the loop amount sensing sensor 32 is changed from the Low state to the High state illustrated in FIG. 17 at timings X4, X6, and X8, and then, the conveyance velocity V of the recording material 19 in the fixing device 15 varies from V12 (306 mm/sec) to V11 (294 mm/sec). Accordingly, the loop amount of the recording material 19 decreases between the secondary transfer portion 11 and the fixing device 15.

After that, at a timing X9 illustrated in FIG. 17, the rear end portion of the recording material 19 in the traveling direction passes through the secondary transfer nip portion N1 of the secondary transfer portion 11. After that, the CPU 49 ends the control of the loop amount of the recording material 19 in a position of a timing X10 illustrated in FIG. 17. Then, the conveyance velocity V of the recording material 19 in the fixing device 15 is returned to V10 (297 mm/sec to 300 mm/sec) of the initial setting.

In this embodiment, the timing X10 illustrated in FIG. 17 is set to the position of 5 mm on the downstream of the recording material 19 in the traveling direction from the secondary transfer nip portion N1 of the secondary transfer portion 11. Furthermore, in FIG. 17, the loop amount sensing sensor 32 is in the High state, the loop amount sensing sensor 32 is in the ON state, and the loop height H, which is the loop amount of the recording material 19 in a lower direction of FIG. 16 is large. In contrast, the loop amount sensing sensor 32 is in the Low state, the loop amount sensing sensor 32 is in the OFF state, and the loop height H, which is the loop amount of the recording material 19 in the lower direction of FIG. 16 is small. Such process is repeated with respect to each of the pages of the printing job.

The timing where the CPU 49 starts the control of the loop amount of the recording material 19 is a timing where the front end portion of the recording material 19 in the traveling direction passes through the fixing nip portion N2 of the fixing device 15 by a predetermined distance. After that, a conveyance force which is imparted to the recording material 19 is as follow.

The secondary transfer portion 11 is considered in which the recording material 19 is nipped and conveyed in the secondary transfer nip portion N1 formed of the secondary transfer roller 12 and the outer circumferential surface of the intermediate transfer belt 7. Further, the fixing device 15 is considered in which the recording material 19 is nipped and conveyed in the fixing nip portion N2 formed of the fixing roller 16 and the pressure roller 17. Then, a conveyance force due to the secondary transfer portion 11 and the fixing device 15 is dominant as the conveyance force which is imparted to the recording material 19. For this reason, the recording material 19 is adsorbed by only the suction force due to the suction fan 44 without being nipped, and thus, the influence of the conveyance force due to the conveying belt 14 is substantially eliminated.

The conveyance force of the recording material 19 due to the secondary transfer portion 11 and the fixing device 15 is sufficiently larger than the conveyance force of the recording material 19 due to the conveying belt 14. For this reason, there is no problem in considering the control of the loop amount of the recording material 19 and the control of the variable velocity of the conveyance velocity V of the recording material 19 in the conveying belt 14 independently. Obviously, the control of the variable velocity of the conveyance velocity V of the recording material 19 in the conveying belt 14 may be performed along with the control of the variable velocity of the conveyance velocity V of the recording material 19 in the fixing device 15.

The variable velocity of the conveyance velocity V of the recording material 19 in the conveying belt 14 is controlled until the front end portion of the recording material 19 in the traveling direction reaches the fixing nip portion N2 of the fixing device 15 between the secondary transfer portion 11 and the fixing device 15. Then, the front end portion of the recording material 19 in the traveling direction reaches the fixing nip portion N2 of the fixing device 15, and then, the loop of the recording material 19 is controlled between the fixing device 15 and the conveying belt 14 illustrated in FIG. 14A. Accordingly, the loop amount of the recording material 19 between the secondary transfer portion 11 and the fixing device 15 can be constantly optimized.

A case is considered in which a conveyance distance between the secondary transfer portion 11 and the fixing device 15 on the conveyance path of the recording material 19 is long, and the conveying belt 14 is disposed between the secondary transfer portion 11 and the fixing device 15. In this case, controlling only the loop of the recording material 19 between the secondary transfer portion 11 and the fixing device 15 is insufficient with respect to the image disturbance P, the breakage, the wrinkle, or the like.

Therefore, the CPU 49 performs the following control such that the loop amount of the recording material 19 becomes proper between the secondary transfer portion 11 and the conveying belt 14 or between the conveying belt 14 and the fixing device 15. The conveyance velocity V of the recording material 19 in the conveying belt 14 varies. Accordingly, the occurrence of the image disturbance P, the breakage, the wrinkle, or the like can be suppressed, and a high-definition image and product can be obtained.

The conveyance velocity V of the recording material 19 in the conveying belt 14 where the recording material 19 is sucked and conveyed between the secondary transfer portion 11 and the fixing device 15 is as follow. The conveying belt 14 has the first velocity V1 where the recording material 19 is received from the secondary transfer portion 11. Further, the conveying belt 14 has the second velocity V2 where the recording material 19 is delivered from the conveying belt 14 to the fixing device 15.

Then, the second velocity V2 is set to a velocity which is faster than the first velocity V1. Then, when the recording material 19 is delivered to the fixing device 15, the loop is actively formed on the recording material 19 between the conveying belt 14 and the fixing device 15. Accordingly, the corrugation of the recording material 19 is suppressed, and the recording material 19 is in a state where a stress is not imparted. Accordingly, the occurrence of the image disturbance P, the wrinkle, the breakage, or the like in the fixing nip portion N2 of the fixing device 15 is suppressed, and a high-definition image and product can be obtained. In addition, the recording material 19 can be reliably sensed by the post-transfer sensor 31.

In this embodiment, the conveyance velocity (a transfer velocity) V of the recording material 19 in the secondary transfer portion 11 (the transfer portion) and the conveyance velocity V of the recording material 19 in the conveying belt 14 at the time of receiving the recording material 19 from the secondary transfer portion 11 (the transfer portion) are set to be approximately the same. Accordingly, the conveyance velocity V of the recording material 19 in the conveying belt 14 is set not to be faster than the conveyance velocity (the transfer velocity) V of the recording material 19 in the secondary transfer portion 11 (the transfer portion).

The recording material 19 is sensed by the post-transfer sensor 31 (the sensing portion). At this time, it is confirmed whether or not the recording material 19 is wound around the outer circumferential surface of the intermediate transfer belt 7. At this time, the recording material 19 is set not to be separated from the post-transfer guide 35 (the conveyance guide) between the secondary transfer portion 11 (the transfer portion) and the conveying belt 14.

A case is considered in which the conveying belt 14 is rotated at a high velocity of the second velocity V2 (306 mm/sec) from the start. In this case, there is a case where the recording material 19 is separated from the post-transfer guide 35 (the conveyance guide) between the secondary transfer portion 11 (the transfer portion) and the conveying belt 14. As a result thereof, a sensing error occurs such that the recording material 19 is not capable of being sensed by the post-transfer sensor 31 (the sensing portion) regardless of the winding of the recording material 19 with respect to the outer circumferential surface of the intermediate transfer belt 7.

For example, the loop is formed on the lower side of FIG. 4 towards the post-transfer sensor 31 (the sensing portion) side such that the recording material 19 is in a convex state. At this time, the conveyance velocity (the transfer velocity) V of the recording material 19 in the secondary transfer portion 11 (the transfer portion) may be set to be faster than the conveyance velocity V of the recording material 19 in the conveying belt 14 at the time of receiving the recording material 19 from the secondary transfer portion 11 (the transfer portion).

Furthermore, it is confirmed that the recording material 19 is not wound around the outer circumferential surface of the intermediate transfer belt 7. For this reason, the timing T3 illustrated in FIG. 4 and FIG. 10 is set to the following timing where the recording material 19 can be more reliably sensed by the post-transfer sensor 31 (the sensing portion). The timing T3 is set to a timing where the recording material 19 reaches the belt conveying portion 13. Further, the timing T3 is set to a timing before the front end portion of the recording material 19 in the traveling direction reaches the fixing nip portion N2. Further, the conveyance velocity V of the recording material 19 in the conveying belt 14 is set to a timing before the velocity varies from the first velocity V1 (300 mm/sec) to the second velocity V2 (306 mm/sec).

The belt conveying portion 13 adsorbs the recording material 19. For this reason, the recording material 19 is sensed by the post-transfer sensor 31 (the sensing portion) at a timing where the recording material 19 reaches the belt conveying portion 13. At the subsequent timing, the winding of the recording material 19 with respect to the outer circumferential surface of the intermediate transfer belt 7 or the uplift of the recording material 19 does not occur.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-134646, filed Jul. 7, 2016, which is hereby incorporated by reference herein in its entirety.

What is claimed is:

1. An image forming apparatus, comprising:
a transfer portion which transfers a toner image onto a recording material;
a fixing portion which fixes the toner image onto the recording material; and
a belt conveying portion which includes a belt that adsorbs the recording material between the transfer portion and the fixing portion, and conveys the recording material,
wherein the belt conveying portion conveys the recording material at a first velocity at the time of receiving a front end portion of the recording material in a traveling direction from the transfer portion, and
the belt conveying portion conveys the recording material at a second velocity before a rear end portion of the recording material in the traveling direction leaves the transfer portion at the time of delivering the front end portion of the recording material in the traveling direction to the fixing portion, and
the second velocity is faster than the first velocity.

2. The image forming apparatus according to claim 1,
wherein the second velocity is faster than a conveyance velocity of the recording material in the fixing portion.

3. The image forming apparatus according to claim 1,
wherein the second velocity is faster than a conveyance velocity of the recording material in the transfer portion.

4. The image forming apparatus according to claim 1,
wherein a conveyance velocity of the recording material in the fixing portion is less than or equal to a conveyance velocity of the recording material in the transfer portion.

5. The image forming apparatus according to claim 1,
wherein a conveyance velocity of the recording material in the belt conveying portion is set to the second velocity before the front end portion of the recording material in the traveling direction reaches a fixing nip portion of the fixing portion.

6. The image forming apparatus according to claim 1,
wherein a conveyance velocity of the recording material in the belt conveying portion is set to the first velocity before the front end portion of the recording material in the traveling direction reaches a surface of the belt of the belt conveying portion.

7. The image forming apparatus according to claim 1, further comprising:
a sensing portion which senses the recording material, between the transfer portion and the belt conveying portion.

8. The image forming apparatus according to claim 7,
wherein the sensing portion senses that an uplift of the recording material passing through the transfer portion or a winding of the recording material in the transfer portion.

9. The image forming apparatus according to claim 8,
wherein a conveyance velocity of the recording material in the belt conveying portion is set to the second velocity before the front end portion of the recording material in the traveling direction reaches a fixing nip portion of the fixing portion and after sensing of the sensing portion is ended.

10. The image forming apparatus according to claim 1, further comprising:
a conveyance guide, between the transfer portion and the belt conveying portion,
wherein the conveyance guide includes a neutralizing portion of the recording material.

11. The image forming apparatus according to claim 1, further comprising:
a loop sensing portion which is provided between the transfer portion and the fixing portion and senses a loop amount of the recording material; and
a controller which controls a conveyance velocity of the recording material in the fixing portion.

12. The image forming apparatus according to claim 11,
wherein a conveyance velocity of the recording material in the belt conveying portion is changed at the same time as sensing of the loop amount of the recording material in the loop sensing portion is started or after the sensing of the loop amount is started.

13. The image forming apparatus according to claim 1,
wherein the second velocity is changed according to a basis weight of the recording material.
